(19) United States
(12) Patent Application Publication
(10) Pub. No.: US 2026/0028514 A1
(43) Pub. Date: Jan. 29, 2026

(54) OBJECT COMPRISING A SEALING LAYER

(71) Applicant: SABIC GLOBAL TECHNOLOGIES B.V., Bergen op Zoom (NL)

(72) Inventors: Ling FAN, Shanghai (CN); Nakul RANADE, Rosenberg, TX (US); Pei SUN, Shanghai (CN); Li YUAN, Shanghai (CN); You Jun WU, Shanghai (CN)

(21) Appl. No.: 18/997,951

(22) PCT Filed: Jul. 24, 2023
(86) PCT No.: PCT/EP2023/070484

§ 371 Date: Jan. 23, 2025

(30) Foreign Application Priority Data
Jul. 29, 2022 (WO) PCT/CN2022/109007
Sep. 20, 2022 (EP) 22196645.0

(51) Int. Cl. C09K 3/10; B32B 27/08; B32B 27/30; B32B 27/32

(52) U.S. Cl. CPC C09K 3/10; B32B 27/08; B32B 27/306; B32B 27/32; B32B 2250/03; B32B 2250/04; B32B 2250/05; B32B 2250/246; B32B 2307/72; B32B 2307/7376; C09K 2003/1084; C09K 2200/062

(57) ABSTRACT

The present invention relates to an object comprising a sealing layer, wherein the sealing layer comprises a polyethylene comprising moieties derived from ethylene and moieties derived from an α-olefin comprising 4 to 10 carbon atoms, the polyethylene having a density of ≥870 and ≤920 kg/m³, preferably of ≥890 and ≤910 kg/m³, as determined in accordance with ASTM D792 (2013), wherein the polyethylene has: ⋅a fraction of material that is eluted in analytical temperature rising elution fractionation (a-TREF) at a temperature ≤30.0° C. of ≥ 5.0 wt % and ≤15.0 wt %, preferably ≥7.5 wt % and ≤12.5 wt %, with regard to the total weight of the polyethylene; ⋅two distinct peaks in the a-TREF curve in the elution temperature range of between 50.0 and 90.0° C., wherein the elution temperature gap between the two peaks is ≤20.0° C., preferably ≤17.5° C.; and, an M_{w}/Mₙ ratio of ≥3.0, preferably ≥3.0 and ≤4.5, as determined in accordance with ASTM D6474 (2012). Such object exhibits a desirably low seal initiation temperature, and a desirably broad hot tack window.

### CROSS REFERENCE TO RELATED APPLICATIONS

This application is a National Stage application of PCT/EP2023/070484, filed Jul. 24, 2023, which claims the benefit of Application No. PCT/CN2022/109007, filed Jul. 29, 2022 and European Application No. 22196645.0, filed Sep. 20, 2022, both of which are incorporated by reference in their entirety herein.

### BACKGROUND

The present invention relates to an object comprising a sealing layer, in particular to a film or laminate comprising a sealing layer, such as for packaging applications, wherein the sealing layer comprises a polyethylene.

Objects, such as films or laminates, that comprise a sealing layer comprising polyethylene materials are abundantly used in a wide variety of applications. A particular example where such objects find their application is in packaging, such as food packaging. The use of polyethylenes allows for packaging of products in a hygienic manner, contributes to preservation of the packaged products for a prolonged period, and allows the packaging process to be performed in an economically attractive way. Further, polyethylene packaging materials can be produced with a highly attractive appearance.

In the field of objects that can be used for packaging, a particular aspect relates to the sealing of such objects. In commercial use, such as in packaging of foodstuff products, the packaging object often is closed by contacting two layers of material with one another, and applying heat to at least that area of those layers where a closed seal is to be formed. The applied heat then leads to local softening of the materials, such as the polyethylenes that may be present in such layers. This leads to a certain adhesion between the two softened layers, which, upon cooling, results in a closed seal, thus forming a packaging object that contains the desired contents separated from the surrounding atmosphere.

Such packages are well known in everyday applications, and allow for example for a significant increase in the retention time of the contained products.

In such packaging solutions, the seals that are produced using such heat-sealing technology as described above need to have a certain strength. This is required in order to be able to produce a package that, during production, transport, storage, and consumer use, is able to withstand certain forces that is may be subjected to, and which it should be considered able to withstand. Therefore, the strength of the seal should be above a certain threshold.

What is further important, in view of the process efficiency of the packaging process as well as the energy consumption during the packaging process, is that such seal having a desirably high strength can be produced at a sealing temperature that is desirably low. The lower the temperature at which the seal can be formed, the less energy is to be employed. A further benefit of a lower temperature that is required for seal formation is that the contents of the package are less subject to elevated temperatures, which, for example in the case of packaging of foodstuffs, may be beneficial for the retention of the quality of the packaged contents.

A further important property in such packaging solutions based on polyethylene materials is the so-called hot tack strength. In the context of the present invention, the hot tack strength is to be understood as the strength of a seal made in a film by heat-sealing immediately after sealing, before the seal has cooled down; thus the strength at elevated temperature. The hot tack strength affect the efficiency of the packaging process, for example the speed at which the packaging line can be operated. The higher the hot tack strength, the less cooling time is required upon seal formation prior to further processing of the package, i.e. the earlier the strength of a seal is of such magnitude as to be able to withstand exerted forces without damaging the seal, the shorter the cycle time in for example continuous packaging machines.

It is also desirable that the hot-tack strength is relatively high over a broad temperature range. This allows for being able to produce the seal in a broad operating window; the sealing layer in such situation is more forgiving to change of sealing and operating temperature, thus contributes to flexibility in the packaging process.

Presently, certain further drivers emerge that are to be considered in view of optimisation of material formulations that are to be used in sealable objects such as packaging films and laminates. These drivers include a desire for use of material in a single object wherein the materials that are used in that object form part of the same family of materials, for example wherein a very large fraction or preferably all of the polymer materials are from the same polymer family, such as from the family of polyethylenes. In such case, the object is more suitable for recycling purposes, such as for example via mechanical or chemical recycling. The higher the degree of similarity between different polymer materials that are used in an object, the easier to re-use the material in high-value recycling solutions. Another emerging driver is the desire to reduce the quantity of materials that are used in an object such as a packaging application. Reduction of material used in such application not only reduces the carbon footprint throughout the production process, but also reduces the quantity of waste that after the useful service life of the object is to be processed.

These industry drivers also affect the formulation of materials that are to be used in the sealing layers of such objects. Particularly, a need continues to exist for objects wherein the sealing layers allow for low temperature sealing at high seal strengths and hot tack strengths.

### SUMMARY

This is now achieved according to the present invention by an object comprising a sealing layer, wherein the sealing layer comprises a polyethylene comprising moieties derived from ethylene and moieties derived from an α-olefin comprising 4 to 10 carbon atoms, the polyethylene having a density of ≥870 and ≤920 kg/m³, preferably of ≥890 and ≤910 kg/m³, as determined in accordance with ASTM D792 (2013),

wherein the polyethylene has:
a fraction of material that is eluted in analytical temperature rising elution fractionation (a-TREF) at a temperature ≤30.0° C. of ≥5.0 wt % and ≤15.0 wt %, preferably ≥7.5 wt % and ≤12.5 wt %, more preferably ≥11.0 wt % and ≤12.5 wt %, with regard to the total weight of the polyethylene;
two distinct peaks in the a-TREF curve in the elution temperature range of between 50.0 and 90.0° C., wherein the elution temperature gap between the two peaks is ≤20.0° C., preferably ≤17.5° C., more preferably ≥5.0 and ≤17.5° C., even more preferably ≥15.0 and ≤17.5° C.; and
an M_{w}/Mₙ ratio of ≥3.0, preferably ≥3.0 and ≤4.5, more preferably ≥3.0 and ≤4.0, even more preferably >3.0 and <4.0, yet even more preferably >3.2 and <3.7, as determined in accordance with ASTM D6474 (2012).

Such object exhibits a desirably low seal initiation temperature, and a desirably broad hot tack window. In the context of the present invention, the seal initiation temperature is the lowest temperature at which a seal having a strength of 5.0 N/15 mm can be produced, as determined in accordance with ASTM F88 (2015). The hot tack window is to be understood to be the range of temperature allowing for sealing at a hot tack strength of ≥1.0 N/15 mm, as determined in accordance with ASTM F1921-B (2021).

It is particularly preferable that the polyethylene has a short chain branching ratio (SCBR) of ≥1.10 and ≤1.50, preferably of ≥1.20 and ≤1.50, even more preferably of ≥1.30 and ≤1.50, wherein SCBR is defined as:

$$S C B R = \frac{S C {B}_{500}}{S C {B}_{10}}$$

wherein SCB₅₀₀ is the quantity of short chain branches (SCB) of the polyethylene at M_{w}=500,000 g/mol and SCB₁₀ is the quantity of short chain branches of the polyethylene at M_{w}=10,000 g/mol, wherein the SCB quantity is determined via GPC-IR and expressed as the number of branches per 1000 carbon atoms (/1000C).

The polyethylene may for example have a melt mass-flow rate determined at 190° C. under a load of 2.16 kg in accordance with ASTM D1238-13 of ≥0.2 and ≤10.0 g/10 min, preferably ≥0.5 and ≤5.0, more preferably ≥0.5 and ≤2.0.

It is preferred that the sealing layer comprises ≥50.0 wt % of the polyethylene, with regard to the total weight of the sealing layer, preferably the sealing layer comprises ≥60.0 wt % and ≤90.0 wt % of the polyethylene.

The sealing layer may for example comprise ≥98.0 wt % of ethylene-based polymer materials, preferably the sealing layer comprises no polymer materials other than ethylene-based polymer materials, with regard to the total weight of the sealing layer. In the context of the present invention, ethylene-based polymer materials are to be understood to be polymer materials wherein at least 50.0 wt % of the polymeric units is derived from ethylene, preferably at least 70.0 wt %, with regard to the total weight of the ethylene-based polymer. It is preferred that ethylene-based polymer materials do not contain hetero-atoms in the polymeric chain. It is further preferred that such ethylene-based polymers only comprise polymeric units derived from compounds that are free from hetero-atoms.

The α-olefin comprising 4 to 10 carbon atoms may preferably be selected from 1-butene, 1-hexene and 1-octene, preferably 1-octene. It is preferred that the polyethylene comprises ≥15.0 and ≤30.0 wt % of moieties derived the α-olefin comprising 4 to 10 carbon atoms, with regard to the total weight of the polyethylene. More preferably, the polyethylene comprises ≥15.0 and ≤30.0 wt % of moieties derived an α-olefin comprising 4 to 10 carbon atoms, wherein the α-olefin comprising 4 to 10 carbon atoms is selected from 1-butene, 1-hexene and 1-octene, from 1-octene. Even more preferably, the polyethylene comprises ≥15.0 and ≤30.0 wt % of moieties derived an α-olefin comprising 4 to 10 carbon atoms, wherein the α-olefin comprising 4 to 10 carbon atoms is 1-octene.

It is further preferred that the polyethylene comprises ≥70.0 wt % of moieties derived from ethylene, with regard to the total weight of the polyethylene.

The polyethylene may be produced via a solution polymerisation process. The polyethylene may be produced using a metallocene-type catalyst.

In certain embodiments of the invention, the object is a film or a laminate. Preferably, such film or laminate has a thickness of ≥1 and ≤200 μm, preferably ≥10 and ≤150 μm, more preferably ≥20 and ≤125 μm. The film or laminate may for example be a multi-layer structure. Such film may be produced via cast extrusion processes, via blown films processes, or via cast extrusion followed by solid-state orientation processes, such as tenter-frame orientation processes. Such film or laminate may for comprise the sealing layer as one outer layer or as both outer layers.

It is preferred that such film or laminate comprises ≥75.0 wt % of ethylene-based polymers, preferably ≥80.0 wt %, more preferably ≥90.0 wt %, with regard to the total weight of the film or laminate, even more preferably wherein the film or laminate comprises no polymer materials other than ethylene-based polymer materials. A film or laminate may for example comprise 3-5 layers.

### DETAILED DESCRIPTION

According to the invention, analytical temperature rising elution fractionation, also referred to as a-TREF, may be carried out using a Polymer Char Crystaf-TREF 300 equipped with stainless steel columns having a length of 15 cm and an internal diameter of 7.8 mm, with a solution containing 4 mg/ml of sample prepared in 1,2-dichlorobenzene stabilised with 1 g/l Topanol CA (1, 1,3-tri (3-tert-butyl-4-hydroxy-6-methylphenyl) butane) and 1 g/l Irgafos 168 (tri (2,4-di-tert-butylphenyl) phosphite) at a temperature of 150° C. for 1 hour. The solution may be further stabilised for 45 minutes at 95° C. under continuous stirring at 200 rpm before analyses.

For analyses, the solution was crystallised from 95° C. to 30° C. using a cooling rate of 0.1° C./min. Elution may be performed with a heating rate of 1° C./min from 30° C. to 140° C. The set-up may be cleaned at 150° C. The sample injection volume may be 300 μl, and the pump flow rate during elution 0.5 ml/min. The volume between the column and the detector may be 313 μl. The fraction that is eluted at a temperature of ≤30.0° C. may in the context of the present invention be calculated by subtracting the sum of the fraction eluted >30.0° C. from 100%, thus the total of the fraction eluted ≤30.0° C., and the fraction eluted >30.0° C. to add up to 100.0 wt %.

Particularly, a-TREF may be carried out using a Polymer Char Crystaf-TREF 300 using a solution containing 4 mg/ml of the polymer in 1,2-dichlorobenzene, wherein the solution is stabilised with 1 g/l 1,1,3-tri (3-tert-butyl-4-hydroxy-6-methylphenyl) butane and 1 g/l tri (2,4-di-tert-butylphenyl) phosphite) at a temperature of 150° C. for 1 hour, and further stabilised for 45 minutes at 95° C. under continuous stirring at 200 rpm, wherein the prior to analyses the solution is crystallised from 95° C. to 30° C. using a cooling rate of 0.1° C./min, and elution is performed at a heating rate of 1° C./min from 30° C. to 140° C., and wherein the equipment has been cleaned at 150° C.

In the context of the present invention, the SCB quantity is determined via infrared-detection gel permeation chromatography (GPC-IR). GPC-IR analysis may for example be performed using a chromatographer, such as a Polymer Char GPC-IR system, equipped with three columns of internal diameter 7.5 mm and 300 mm length, packed with of particles of 13 μm average particle size, such as Polymer Laboratories 13 μm PLgel Olexis, operating at 160° C., equipped with an MCT IR detector, wherein 1,2,4-trichlorobenzene stabilised with 1 g/l butylhydroxytoluene may be used as eluent at a flow rate of 1 ml/min, with a sample concentration of 0.7 mg/ml and an injection volume of 200 μl, with molar mass being determined based on the universal GPC principle using a calibration made with PE narrow and broad standards in the range of 0.5-2800 kg/mol, Mw/Mn—4 to 15 in combination with known Mark Houwink constants of PE-calibrant alfa=0.725 and log K=−3.721. Short chain branching content was determined via IR determination of the intensity ratio of CH₃ (I_{CH3}) to CH₂ (I_{CH2}) coupled with a calibration curve. The calibration curve is a plot of SCB content (X_{scB}) as a function of the intensity ratio of I_{CH3}/I_{CH2}. To obtain a calibration curve, a group of polyethylene resins (no less than 5) (SCB Standards) were used. All these SCB Standards have known SCB levels and flat SCBD profiles. Using SCB calibration curves thus established, profiles of short chain branching distribution across the molecular weight distribution can be obtained for resins fractionated by the IR5-GPC system under exactly the same chromatographic conditions as for these SCB standards. A relationship between the intensity ratio and the elution volume is converted into SCB distribution as a function of MWD using a predetermined SCB calibration curve (i.e., intensity ratio of I_{CH3}/I_{CH2} vs. SCB content) and MW calibration curve (i.e., molecular weight vs. elution time) to convert the intensity ratio of I_{CH3}/I_{CH2} and the elution time into SCB content and the molecular weight, respectively.

The invention will now be illustrated by the following non-limiting examples.

In the experiments conducted in the course of the present invention, the following polyethylene materials were used.

| | |
|---|---|
| PE1 | SABIC Cohere 8197L, an ethylene/1-octene |
| | copolymer obtainable from SABIC |
| PE2 | SABIC Cohere S100, an ethylene/1-octene |
| | copolymer obtainable from SABIC |
| PE3 | Dow Affinity PF 1146G, an ethylene/1-octene |
| | copolymer obtainable from Dow Chemical |

The materials PE1-PE3 were analysed to demonstrate the following product properties:

| | PE1 | PE2 | PE3 |
|---|---|---|---|
| MFR2 (g/10 min) | 1.0 | 1.0 | 1.0 |
| Density (kg/m³) | 0.901 | 0.900 | 0.899 |
| Fraction a-TREF ≤30° C. (wt %) | 12.2 | 20.8 | 5.4 |
| Peak gap (° C.) | 16.3 | 23.9 | Single peak, |
| | | | no gap |
| M_{w}/Mₙ | 3.5 | 2.9 | 2.5 |
| SCBR | 1.40 | 1.01 | 0.86 |

wherein:
The MFR2 is the melt mass-flow rate, determined at 190° C. under a load of 2.16 kg, in accordance with ASTM D1238 (2013);
The density is determined in accordance with ASTM D792 (2013)
The fraction a-TREF ≤30° C. is the fraction eluted in an a-TREF analysis conducted as described above below 30° C.;
The peak gap is the elution temperature gap between the two peaks P2 and P1(P2-P1);
P1 is the temperature at which the first peak, i.e. the peak eluting at the lowest temperature, in the elution interval between 50.0 and 90.0° C., occurs in the a-TREF analysis;
P1 is the temperature at which the second peak, i.e. the peak eluting at the highest temperature, in the elution interval between 50.0 and 90.0° C., occurs in the a-TREF analysis;
the SCB was determined via GPC-IR; SCB@10K is the SCB at M_{w}=10,000 g/mol; SCB@100K is the SBC at M_{w}=100,000 g/mol; SCB@500K is the SBC at M_{w}=500,000 g/mol; SCBR=SCB@500K/SCB@10K;
the weight-average molecular weight (M_{w}) and the number-average molecular weight (Mn) were determined in accordance with ASTM D6474 (2012).

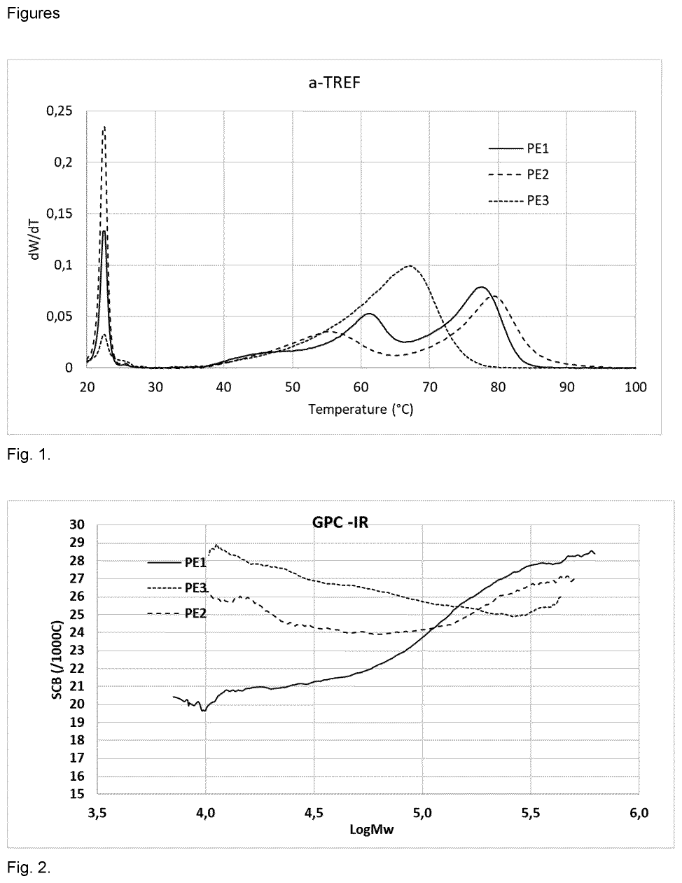

In FIG. 1, the a-TREF elution profiles of each of the polymers PE1, PE2 and PE3 is presented, wherein the eluted fraction at given temperature (dW/dT) is plotted against the elution temperature. In FIG. 2, a plot of the short chain branch content (SCR), in/1000C, is plotted as function of the molecular weight M_{w} for the polymers PE1, PE2 and PE3, showing the distribution of the quantity of short chain branches for each molecular weight fraction.

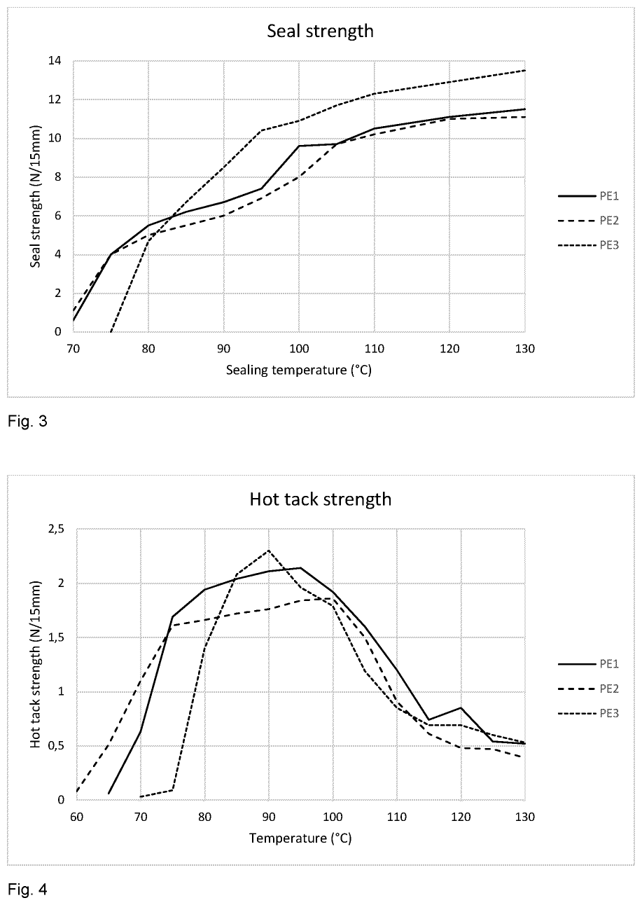

Using these materials, films were produced using an STSC blow film machine, at an output of 8 kg/h, at a process temperature of 200° C. The films had a thickness of 50 μm. Of each of the films that were produced, the seal strength was determined of seals produced at different temperatures, in accordance with ASTM F88 (2015), on a seal of 15 mm width. In the table below, the seal strengths of each of the films is presented, expressed in N. FIG. 3 provides a graphical representation of these data.

| | | | PE1 | PE2 | PE3 |
|---|---|---|---|---|---|
| Example | | | Seal Strength | | |
| Sealing | 70° | C. | 0.6 | 1.1 | |
| temperature | 75° | C. | 4.0 | 4.0 | 0.1 |
| | 80° | C. | 5.5 | 5.0 | 4.7 |
| | 85° | C. | 6.2 | 5.5 | 6.7 |
| | 90° | C. | 6.7 | 6.0 | 8.5 |
| | 95° | C. | 7.4 | 6.9 | 10.4 |
| | 100° | C. | 9.6 | 8.0 | 10.9 |
| | 105° | C. | 9.7 | 9.7 | 11.7 |
| | 110° | C. | 10.5 | 10.2 | 12.3 |
| | 120° | C. | 11.1 | 11.0 | 12.9 |
| | 130° | C. | 11.5 | 11.1 | 13.5 |

Of each of the films that were produced, the hot tack strength was determined of seals produced at different temperatures, in accordance with ASTM F1921-B (2021), on a seal of 15 mm width. In the table below, the hot tack strengths of each of the films is presented, expressed in N. FIG. 4 provides a graphical representation of these data.

| | | | PE1 | PE2 | PE3 |
|---|---|---|---|---|---|
| Example | | | Hot tack strength | | |
| Temperature | 60° | C. | | 0.08 | |
| | 65° | C. | 0.06 | 0.51 | |
| | 70° | C. | 0.63 | 1.10 | 0.03 |
| | 75° | C. | 1.69 | 1.61 | 0.09 |
| | 80° | C. | 1.94 | 1.66 | 1.40 |
| | 85° | C. | 2.04 | 1.72 | 2.08 |
| | 90° | C. | 2.11 | 1.76 | 2.30 |
| | 95° | C. | 2.14 | 1.84 | 1.96 |
| | 100° | C. | 1.92 | 1.86 | 1.79 |
| | 105° | C. | 1.60 | 1.50 | 1.19 |
| | 110° | C. | 1.20 | 0.91 | 0.85 |
| | 115° | C. | 0.74 | 0.61 | 0.69 |
| | 120° | C. | 0.58 | 0.48 | 0.69 |
| | 125° | C. | 0.54 | 0.47 | 0.60 |
| | 130° | C. | 0.52 | 0.39 | 0.53 |

Using the materials PE1-PE3, multi-layer films F1-F6 were produced using a blow moulding film machine, at an output of 6 kg/h, at a process temperature of 200° C. For experimental purposes, 5-layer films were produced having the structure as in the table below:

| | | | |
|---|---|---|---|
| Layer 1 | Sealing layer | 35 | μm |
| Layer 2 | Tie layer | 4 | μm |
| Layer 3 | EVOH layer | 6 | μm |
| Layer 4 | Tie layer | 4 | μm |
| Layer 5 | PE layer | 50 | μm |

The tie layer material was an maleic anhydride-modified linear low-density polyethylene, of grade Orevac 18341, obtainable from Arkema. The EVOH was an ethylene vinyl alcohol copolymer, of grade EVAL H171B, obtainable from Kuraray. The PE of the PE layer a metallocene-catalysed linear low-density polyethylene of grade Exceed 1018MA, obtainable 10 from ExxonMobil. For the sealing layer, the below formulations were used in the multi-layer examples. The PE used in the sealing layer also was the Exceed 1018MA.

| | |
|---|---|
| F1 | 20 wt % PE1, 80 wt % PE |
| F2 | 70 wt % PE1, 30 wt % PE |
| F3 | 20 wt % PE2, 80 wt % PE |
| F4 | 70 wt % PE2, 30 wt % PE |
| F5 | 20 wt % PE3, 80 wt % PE |
| F6 | 70 wt % PE3, 30 wt % PE |

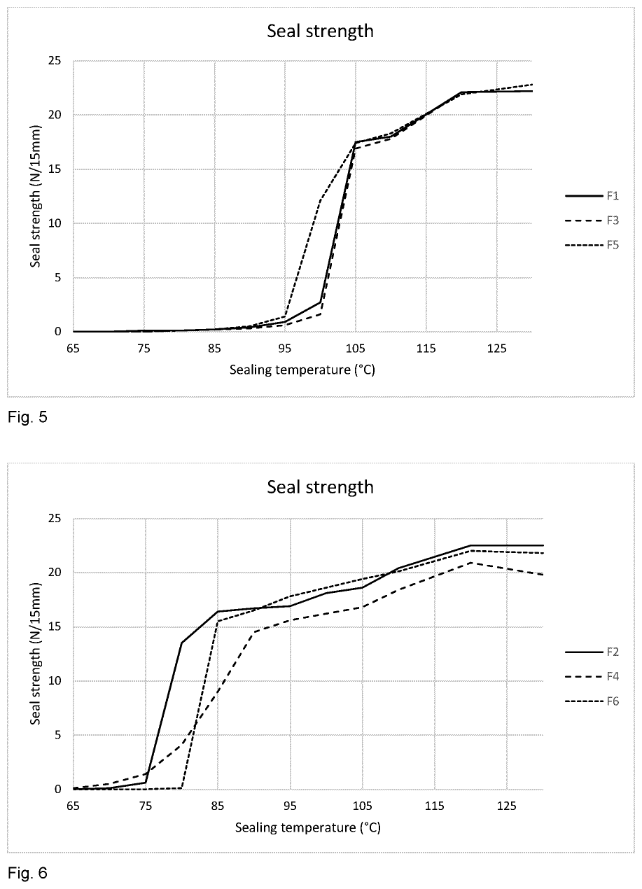

Of each of the multi-layer films F1-F6, the seal strength was determined of seals produced at different temperatures, in accordance with ASTM F88 (2015), on a seal of 15 mm width. In the table below, the seal strengths of each of the films is presented, expressed in N. FIGS. 5 and 6 provide a graphical representation of these data.

| | | | Example | | | | | |
|---|---|---|---|---|---|---|---|---|
| | | | F1 | F2 | F3 | F4 | F5 | F6 |
| | | | Seal Strength | | | | | |
| Sealing | 65° | C. | | | | 0.1 | | |
| temperature | 70° | C. | | 0.1 | | 0.5 | | |
| | 75° | C. | 0.1 | 0.6 | | 1.4 | | |
| | 80° | C. | 0.1 | 13.5 | 0.1 | 4.1 | 0.1 | 0.1 |
| | 85° | C. | 0.2 | 16.4 | 0.2 | 9.0 | 0.2 | 15.5 |
| | 90° | C. | 0.4 | 16.7 | 0.3 | 14.5 | 0.5 | 16.5 |
| | 95° | C. | 0.9 | 16.9 | 0.6 | 15.6 | 1.4 | 17.8 |
| | 100° | C. | 2.7 | 18.1 | 1.6 | 16.2 | 12.1 | 18.6 |
| | 105° | C. | 17.5 | 18.6 | 16.9 | 16.8 | 17.4 | 19.4 |
| | 110° | C. | 18.0 | 20.4 | 17.8 | 18.4 | 18.3 | 20.1 |
| | 120° | C. | 22.1 | 22.5 | 22.1 | 20.9 | 21.9 | 22.0 |
| | 130° | C. | 22.2 | 22.5 | 23.1 | 19.8 | 22.8 | 21.8 |

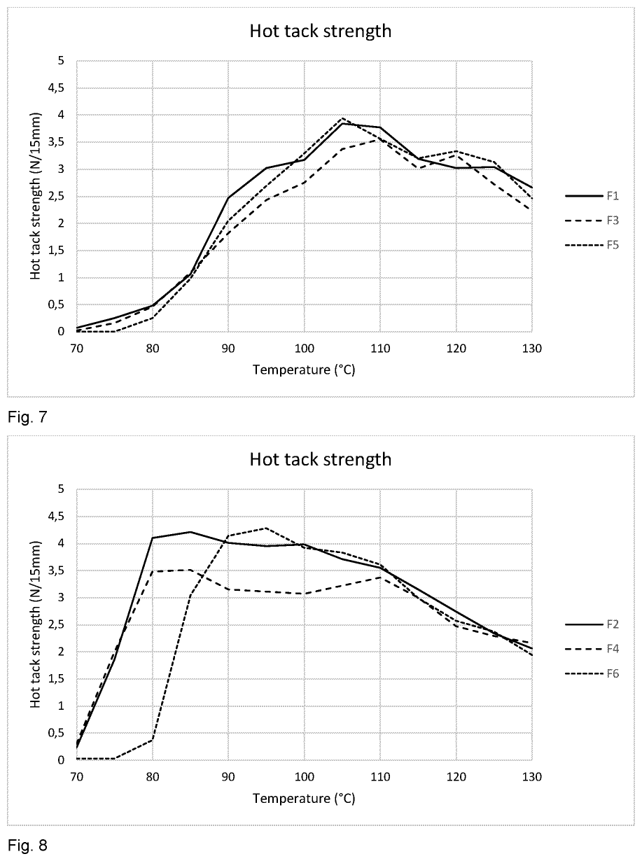

Of each of the films F1-F6, the hot tack strength was determined of seals produced at different temperatures, in accordance with ASTM F1921-B (2021), on a seal of 15 mm width. In the table below, the hot tack strengths of each of the films is presented, expressed in N. FIGS. 7 and 8 provide a graphical representation of these data.

| | | | Example | | | | | |
|---|---|---|---|---|---|---|---|---|
| | | | F1 | F2 | F3 | F4 | F5 | F6 |
| | | | Hot tack strength | | | | | |
| Temperature | 70° | C. | 0.07 | 0.23 | 0.02 | 0.30 | | 0.03 |
| | 75° | C. | 0.25 | 1.86 | 0.16 | 2.00 | | 0.03 |
| | 80° | C. | 0.48 | 4.10 | 0.46 | 3.48 | 0.25 | 0.37 |
| | 85° | C. | 1.06 | 4.21 | 1.09 | 3.51 | 0.98 | 3.04 |
| | 90° | C. | 2.47 | 4.01 | 1.82 | 3.15 | 2.05 | 4.14 |
| | 95° | C. | 3.02 | 3.95 | 2.43 | 3.11 | 2.69 | 4.28 |
| | 100° | C. | 3.17 | 3.89 | 2.75 | 3.07 | 3.29 | 3.92 |
| | 105° | C. | 3.84 | 3.71 | 3.37 | 3.22 | 3.94 | 3.83 |
| | 110° | C. | 3.77 | 3.55 | 3.55 | 3.37 | 3.56 | 3.61 |
| | 115° | C. | 3.19 | 3.15 | 3.01 | 3.00 | 3.20 | 2.99 |
| | 120° | C. | 3.02 | 2.74 | 3.26 | 2.47 | 3.33 | 2.57 |
| | 125° | C. | 3.04 | 2.34 | 2.72 | 2.29 | 3.13 | 2.37 |
| | 130° | C. | 2.66 | 2.06 | 2.23 | 2.16 | 2.46 | 1.94 |

1. An object comprising a sealing layer, wherein the sealing layer comprises a polyethylene comprising moieties derived from ethylene and moieties derived from an α-olefin comprising 4 to 10 carbon atoms, the polyethylene having a density of ≥870 and ≤920 kg/m³, as determined in accordance with ASTM D792 (2013),
wherein the polyethylene has:
a fraction of material that is eluted in analytical temperature rising elution fractionation (a-TREF) at a temperature ≤30.0° C. of ≥5.0 wt % and ≤15.0 wt %, with regard to the total weight of the polyethylene;
two distinct peaks in the a-TREF curve in the elution temperature range of between 50.0 and 90.0° C., wherein the elution temperature gap between the two peaks is ≤20.0° C.; and
an M_{w}/Mₙ ratio of ≥3.0, as determined in accordance with ASTM D6474 (2012).

2. The object according to claim 1, wherein the polyethylene has a short chain branching ratio (SCBR) of ≥1.10 and ≤1.50, wherein SCBR is defined as:
$$S C B R = \frac{S C {B}_{500}}{S C {B}_{10}}$$
wherein SCB₅₀₀ is the quantity of short chain branches (SCB) of the polyethylene at M_{w}=500,000 g/mol and SCB₁₀ is the quantity of short chain branches of the polyethylene at M_{w}=10,000 g/mol, wherein the SCB quantity is determined via GPC-IR and expressed as the number of branches per 1000 carbon atoms (/1000C).

3. The object according to claim 1, wherein the polyethylene has a melt mass-flow rate determined at 190° C. under a load of 2.16 kg in accordance with ASTM D1238-13 of ≥0.2 and ≤10.0 g/10 min.

4. The object according to claim 1, wherein the sealing layer comprises ≥50.0 wt % of the polyethylene, with regard to the total weight of the sealing layer.

5. The object according to claim 1, wherein the sealing layer comprises ≥98.0 wt % of ethylene-based polymer materials, with regard to the total weight of the sealing layer.

6. The object according to claim 1, wherein the α-olefin comprising 4 to 10 carbon atoms is selected from 1-butene, 1-hexene and 1-octene.

7. The object according to claim 1, wherein the polyethylene comprises ≥15.0 and ≤30.0 wt % of moieties derived from 1-octene, with regard to the total weight of the polyethylene.

8. The object according to claim 1, wherein the polyethylene comprises ≥70.0 wt % of moieties derived from ethylene, with regard to the total weight of the polyethylene.

9. The object according to claim 1, wherein the polyethylene is produced via a solution polymerisation process, and/or wherein the polyethylene is produced using a metallocene-type catalyst.

10. The object according to claim 1, wherein the object is a film or a laminate.

11. The object according to claim 10, wherein the film or laminate has a thickness of ≥1 and ≤200 μm.

12. The object according to claim 10, wherein the film or laminate has a multi-layer structure.

13. The object according to claim 12, wherein the film or laminate comprises the sealing layer as one outer layer or as both outer layers.

14. The object according to claim 12, wherein the film or laminate comprises ≥75.0 wt % of ethylene-based polymers, with regard to the total weight of the film or laminate.

15. The object according to claim 12, wherein the film or laminate comprises 3-5 layers.
